(19) United States
(12) Patent Application Publication
(10) Pub. No.: US 2005/0030554 A1
(43) Pub. Date: Feb. 10, 2005

(54) Recyclable printing mechanism and related method

(76) Inventors: Bradford N. Dixon, Corvalis, OR (US); John F. Meyer, San Diego, CA (US); David C. Towery, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/638,698

(22) Filed: Aug. 9, 2003

(51) Int. Cl. B41J 1/00

(52) U.S. Cl. 358/1.1

(57) ABSTRACT

An embodiment of a printing apparatus is provided as including a chassis, a print engine supported by the chassis, and a casing of a cardboard material comprising cellulose fiber attached to the chassis and surrounding the print engine when attached to the chassis. A business method for recycling or refurbishing a recyclable printing mechanism is also provided.

### BACKGROUND

Inkjet printing mechanisms, such as inkjet printers may be used in many daily applications. For example, inkjet printers may be connected to computers and used to produce black and white text printouts for professional business applications. Also, some inkjet printers may be connected directly to digital cameras or other devices and used to produce aesthetically pleasing high quality color printouts.

However, typical inkjet printers are designed for long-term use, with refillable or replaceable ink/toner sources, and are too expensive for portable applications, such as for travelers, during business trips or on vacations, or for a single event, such as during parties, where refilling/replacing of the ink/toner is not a concern, and portability is desired whether or not AC (alternating current) power is available.

### BRIEF DESCRIPTION OF THE DRAWINGS

Embodiments of the present invention can be further understood by reference to the following description and attached drawings that illustrate several embodiments. Other features and advantages will be apparent from the following detailed description of these embodiments, taken in conjunction with the accompanying drawings, which illustrate, by way of example, the principles of the invention.

FIG. 1 is a block diagram showing one embodiment of the present invention.

FIG. 2 is a perspective view of one embodiment of the present invention.

FIG. 3 is a flow diagram showing one embodiment of the present invention.

FIG. 4 is a block diagram of one embodiment of the present invention, shown for illustrative purposes only, incorporating a digital camera.

FIG. 5 is a block diagram of one embodiment of the present invention incorporating recyclable components.

FIG. 6 is a block diagram of one embodiment of a wireless data transmission system linking the printer and the cartridge of FIG. 5.

### DETAILED DESCRIPTION OF THE DRAWINGS

In the following description, reference is made to the accompanying drawings, which form a part hereof, and in which is shown by way of illustration an example in which the invention may be practiced. It is to be understood that other embodiments may be utilized and structural changes may be made without departing from the scope of the present invention, as defined by the claims appended below.

I. Exemplary Printing System:

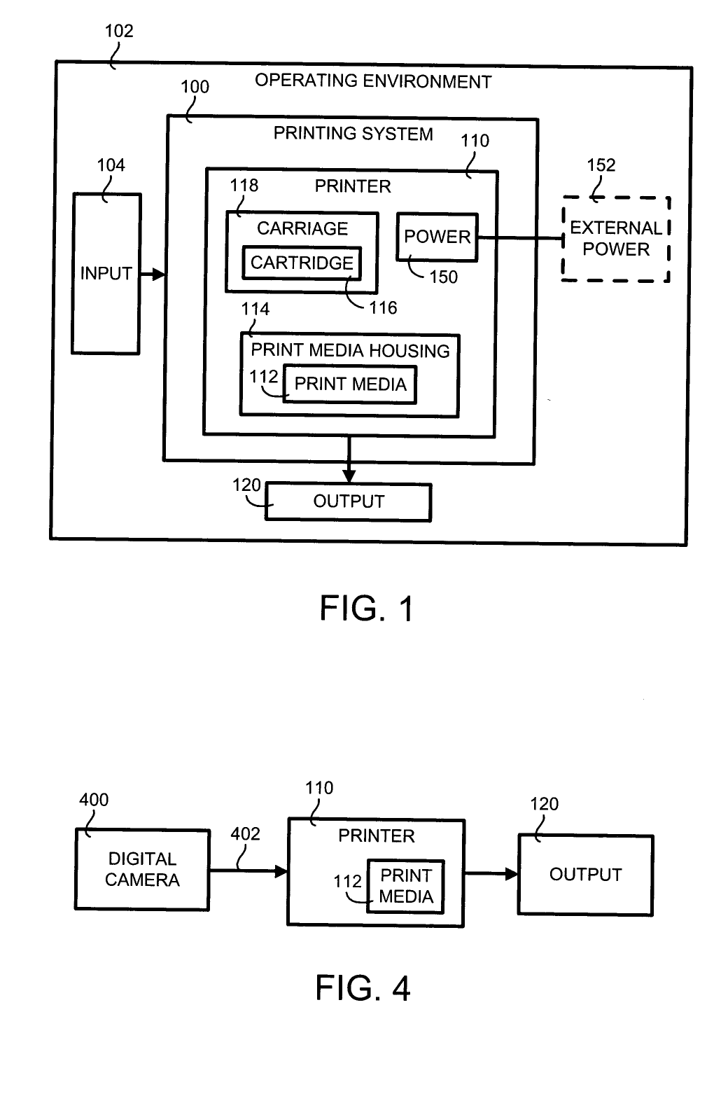

FIG. 1 shows a block diagram of one embodiment of a printing system 100, shown for illustrative purposes only. Printing system 100 may be used in operating environment 102, which may be remote, independent, or included in any other printing environment. For instance, these environments include where AC (alternating current) power may be available or may not be available, such as at the beach or on an airplane.

In one embodiment, printing system 100 includes printer 110 that is a single-event or limited-use printer, without a replaceable colorant(s) source, such as an inkjet ink source(s) for an inkjet printing mechanism or a toner source(s) for electro-photographic printing mechanism. For example, printer 110 is intended to be used during specific occasions, such as by travelers during business trips or on vacations, or by users during parties where it may be desirable to have several printers available for guests in different locations. Of course, the concept “single-event” is used to convey the general idea, although it is apparent that printer 110 may be used for one or more parties, trips, vacations, etc., until the onboard ink supply is exhausted.

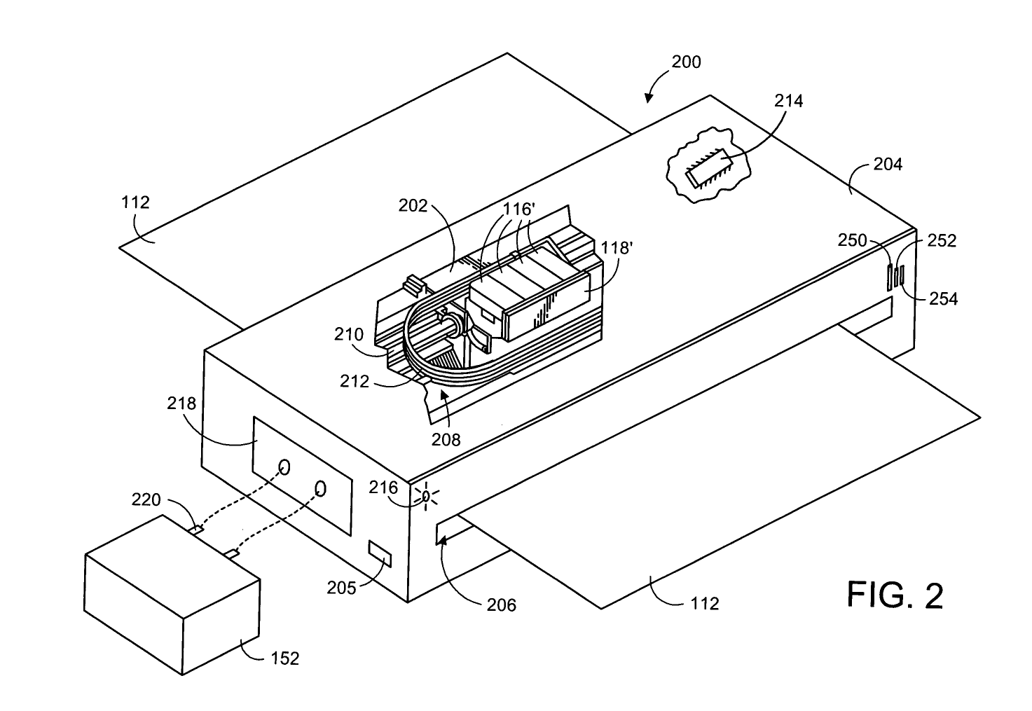

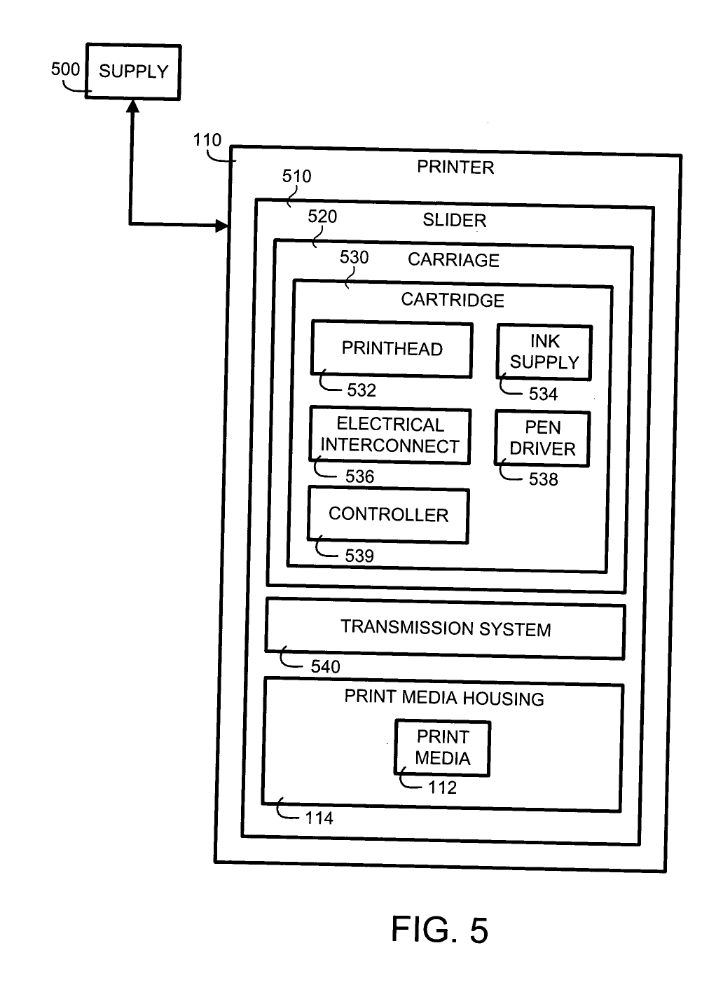

Since the printer 110 has a colorant source which is not replaceable, and since some colorants have a limited shelf life, printer 110 may be marked with an expiration use date (refer to item 205 in FIG. 2). Printer 110 may be pre-configured by the manufacturer to produce a maximum number of printouts or printed upon media sheets 112, for example twenty 4×6 color photo sheets. This maximum output may be determined based upon the available onboard colorant supply, and estimates as to the amount of colorant used per printed sheet. Preconfiguring for a maximum output may be useful in a bundled in sales application, where the printer is sold with the maximum amount of media sheets expected to be printed with printer 110. This preconfiguration may occur, for example, by storing the maximum output value, which in this example corresponds to the bundled number of media sheets, in a controller portion of the printer (for instance in a memory portion of controller 539 of FIG. 5, or controller 214 of FIG. 2). Alternatively, printer 110 may be configured with a counting routine, which monitors the amount of colorant consumed, and provides the operator with a warning when the colorant(s) are approaching empty, allowing early purchase of a new printer for use when the current printer colorant(s) are depleted. Also, printer 110 is recyclable or disposable after the specific occasion is over, the use date has expired, the maximum output has been reached, or the colorants are depleted.

During operation, printing system 100 may receive input data 104 representative of text or images to be printed. After input data 104 is received by printer 110, printer 110 prints the image on print media 112, such as paper or fabric. Printer 110 may include an internal print media housing 114, which receives fresh print media 112 after printer 110 prints a previous media sheet.

Text and images may be printed on media 112 using a colorant-dispensing print engine, which in one embodiment is illustrated as one or more colorant-dispensing print cartridges, such as inkjet ink dispensing print cartridges 116, often referred to in the industry as “pens.” The print cartridge may include an ink container defining an ink reservoir containing ink and a printhead which dispenses ink from the reservoir. The inkjet printhead may be any suitable printhead that uses thermal, piezo-electric, or other ink dispensing technologies. In the inkjet context, print cartridge(s) 116 may be traversed over media 112 using a carriage 118 to print the image thereon to produce a print output 120. In an alternate embodiment, print cartridge(s) 116 may span the entire width of media 112 in an arrangement known as a page wide array, eliminating carriage 118. In another embodiment, print cartridge(s) 116 and carriage 118 may be formed as an integral unit, so during a recycling operation of printer 110 the combined carriage/print cartridge unit may be replaced for refurbishing printer 110. Thus, the print engine in an inkjet context, may take on many different forms, a few of which have been described here.

In some implementations the print engine may include or be complemented by additional cartridges or fluid dispensing heads, such as those which may be used to apply other compositions to be printed image. For example, fluid over-coatings may be used often called “fixers” which may be employed to waterproof the final image or speed drying of the colorants, for example. These additional cartridges or fluid dispensing heads may have the same configuration as the print cartridge(s) 116.

In another embodiment, the colorant-dispensing print engine may be configured for electrostatic or electrophotographic printing, often referred to in the industry as “laser” printing. In such an embodiment, the laser print cartridge 116 is typically stationary, eliminating carriage 118. While a single colorant dispensing laser print cartridge 116 is schematically illustrated in FIG. 1, it should be understood that the schematic nature of FIG. 1 may be interpreted as representing two or more laser print cartridges 116 to provide a palette of colorants for color printing.

In one embodiment, printer 110 may include an internal power supply 150, such as a DC (direct-current) battery power supply. In an alternate embodiment, the printer 110 may receive power from an optional external power source 152 (shown in dotted lines), which may be a DC battery or an AC power source. In another embodiment, the internal power supply 150 may be supplemented or recharged by the external power source 152. The internal power supply 150 facilitates printer portability and operation in environments where AC power is not available, for instance in the wilderness.

FIG. 2 shows one embodiment of an exemplary inkjet printing mechanism, here illustrated as a high-speed inkjet printer 200 incorporating an embodiment of the invention. Generally, printer 200 includes a chassis 202 of a rigid material, such as aluminum or alternatively, recyclable plastic or any other suitable recyclable material, surrounded by an exterior housing or casing 204.

In one embodiment, housing 204 is an integral and rectangular shaped member that is attached to the chassis to prevent the user from accessing the print engine. The housing 204 is devoid of access doors or access mechanisms that would normally permit user access to the print engine. This housing 204 arrangement would reduce the overall cost of the printer. The housing 204 can be constructed of a recyclable material which has components that may be reused in their current state, or broken down (e.g. chemically, mechanically, thermally, etc.) into a more basic composition(s) which may then be fabricated into a new product. For instance, casing 204 may be of a cardboard, for instance of a cellulose fiber material. Casing 204 may be coated with a metallic paint, or if a cardboard type of material is used, with a waterproof coating for durability and aesthetic appeal, or with other finishes, for instance those bearing images or designs. The casing may also bear various operator instruction indicia, easily placed on the exterior surface of casing 204 with a label, for instance displaying an expiration date label 205. Of course in other implementations, this information may be printed directly on the casing, or embossed therein.

Printer 200 may include a media handling system 206, which may be made of a recyclable material, here shown as a mechanism through which a single sheet 112 of print media may be fed manually. In other implementations, printer 200 may include a tray for receiving a stack of fresh print media. Media handling system 206 may include conventional drive rollers (not shown) driven by a motor (not shown), for instance a stepper motor, which may incrementally advance media 112 through a printzone 208. Printer 200 shows media 112 traveling in a “straight through” path, entering on one side of the printer and exiting from the opposite side.

In other implementations, media 112 may travel in a U-shaped path, entering and exiting the printer from the same side. While in printzone 208, media 112 receives ink selectively dispensed specifically from one or more print cartridges 116′, illustrated here as four print cartridges dispensing cyan, yellow, magenta and black ink. The term “ink” as used herein refers to any type of colorant or other coating, such as a “fixer” used to waterproof or speed drying of the final image.

The print cartridges 116′ may be transported through printzone 208 by one specific embodiment of an inkjet carriage 118′ which may traverse along a carriage slider or guide rod 210 supported by chassis 202. The media 112 may be stopped in the printzone 208 while carriage 118′ scans the print cartridges 116′ across the sheet for printing a swath of ink thereon. After a single scan or multiple scans, the printhead 116′ is incrementally advanced to the next printing position within printzone 208. Carriage 118′ again scans across the sheet for printing the next swath of ink. The process repeats until the entire image has been printed on media 112, at which point the printed sheet is ejected.

The illustrated inkjet print cartridges 116′ receive ink from a remote stationary ink supply (not shown) via a series of ink delivery conduits, such as flexible tubing 212. In other implementations, the print cartridges may be a portion of an integral inkjet print cartridge that carries the complete ink supply for each printhead across printzone 208, similar to commercially available disposable inkjet print cartridges, or the printheads may be coupled to separate detachable ink reservoirs, similar to “snapper” systems as known in the industry.

In other implementations, the print cartridges 116′ are either removably or permanently mounted to carriage 118′. In addition, the printhead may be a page wide array that spans the entire width of printzone 208, allowing media 112 to move continuously through printzone 208 during printing.

In the illustrated embodiment, printer 200 carries enough ink to last the lifetime of printer 200. That is, when ink reservoirs are depleted printer 200 may be returned to the manufacturer or its authorized agents for recycling. In this aspect, printer 200 differs from currently available inkjet printers that allow the ink supply to be replenished by an operator. In one embodiment, because casing 204 prohibits access to the print cartridges 116′ and/or the ink supplies, when the ink supplies of print cartridges 116′ are depleted, printer 200 has reached the end of its useful lifetime. In the illustrated embodiment, printhead access is prohibited by omitting printhead/cartridge access doors, openings, etc., which are typically found in replaceable or refillable inkjet systems. Thus, casing 204 surrounds, engulfs, and protects print cartridges 116′ from operator access or interference.

In one embodiment, one or more operator input controls, such as an on/off switch (not shown) may be included on the exterior portions of the printer. Alternatively, casing 204 does not support any external buttons to limit the cost of the printer. In this embodiment, insertion of print media 112 into the handling system 206 may activate printer 200 for operation, eliminating the need for an on/off switch. Printer 200 may also include a controller 214, illustrated schematically in FIG. 2, which receives data input 104 and any operator input if provided by the particular implementation, such as input from an on/off switch or print quality selections (e.g. draft, normal or best). Controller 214 controls operation of carriage 118 and print cartridges 116 of the print engine, in coordination with the movement of media 112 by the media handling system 206 to produce the desired output 120.

Casing 204 may also support one or more indicator lights, such as light 216, which may indicate when printer 200 is turned on, when a print job is being received, or when the useful life of printer 200 is nearing an end, for example. In addition, casing 204 may support one or more digital memory card devices, such as with slots 250, 252, 254 for various digital memory card sizes, which may include compact flash, smart media or secure digital memory cards, for example.

Similar to the printer 110 of FIG. 1, printer 200 may receive power from the independent internal power source 150 (FIG. 1) and/or external power source 152. In the illustrated embodiment, casing 204 supports a power receptacle 218 which may be configured to receive power from electrical conductors, such as conductor 220 coupled to power source 152. In some implementations, receptacle 218 may be recessed into the printer casing 204 so the entire power supply 152 may be removably housed inside the casing.

In general, in one embodiment, portions of the printer that are made with recyclable materials, such as the outer casing, may be recycled by the user or the company that receives the printer after the one-time use. In addition, power source 152 is a battery that can be reused by the manufacturer if recycled or returned by the user. Some parts that are not damaged and that pass inspection, may be used again with minor refurbishing in the manufacture of future printers. The parts of the printer that do not pass inspection may be ground up and fed into a raw material stream for molding into new printers or for other products. Details of the recycling process for the printer and its parts are discussed below.

II. Detailed Description of the Components and Operation:

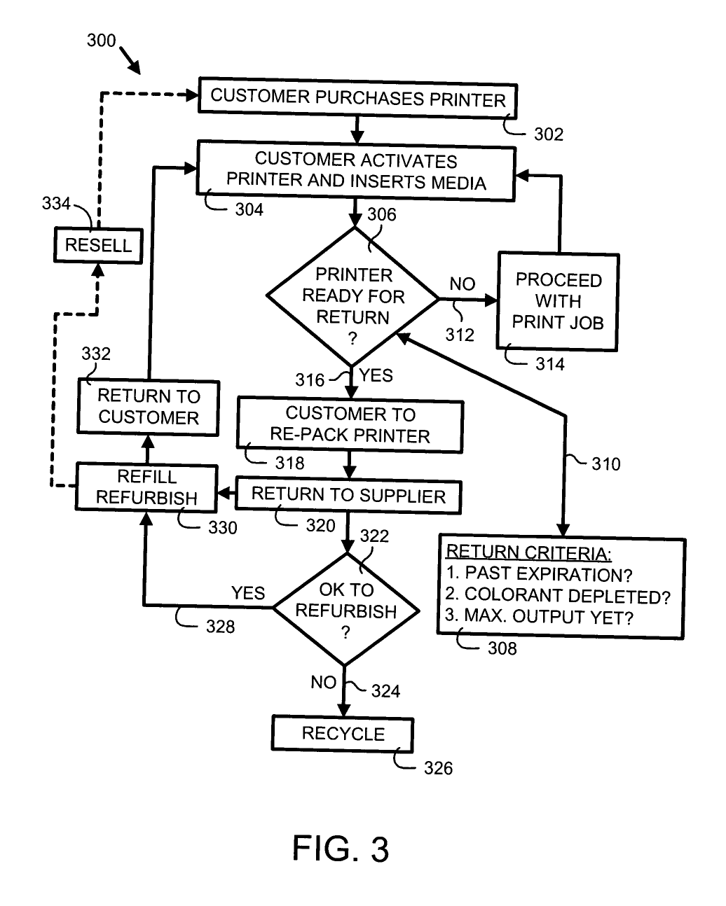

FIG. 3 is a flow diagram a method 300, showing operation of the embodiments of FIGS. 1 and 2, as well as a business method. In a purchasing action 302, a customer may purchase printer 110 or 200. Following the purchase, in an activating operation 304, a customer or other operator activates printer 110, 200 and inserts print media 112, either into print media housing 114 for printer 110, or into handling system 206 for printer 200.

The printer 110, 200 may include a controller 214 that assesses the current status of the printer in a determining operation 306 and may communicate this information to the operator. As discussed above, printer 110, 200 is proposed for a limited use, having non-replaceable colorant dispensing cartridges 116,116′. Several examples were given for determining the lifetime of the printer, as illustrated by return decision criteria 308 which may be stored within controller 214 for use by determining operation 306 (as indicated by double-headed arrow 310), where printer lifetime queries may be made, such as:
(1) Is the printer past or beyond its expiration date?
(2) Is the colorant depleted?
(3) Has the maximum output been reached?
   The first criteria (in FIG. 3, “Past Expiration?”) may require a clocking feature be provided with the printer to automatically keep track of the current date, or indicator light 216 may be used to ask an operator to check the expiration date. For example, casing 204 may display a notation for the operator to check the expiration date when light 216 blinks X number of times, for instance three times (X=3), and to return the printer when past the expiration date. The second criteria (in FIG. 3, “Colorant Depleted?”) may be tracked by a counting routine, for instance a drop counting routine for inkjet printing, or a toner usage counting routine for electrostatic, electrophotographic, or “laser” printing. The third criteria (in FIG. 3, “Max. Output Yet?”) may be tracked by counting the number of media sheets printed, and referring to preselected estimates as to the amount of colorant expected to be applied per page along with the amount of colorant supplied with the printer. The various counting routines may be performed by the controller 214.

If the selected criteria is satisfied (not past expiration date; colorant not depleted; maximum output not exceeded), the printer is not yet ready for return and a NO signal 312 is issued to proceed with a print job operation 314. Following completion of the print job 314, the method may then return to the activation and media insertion operation 304, which at that point may only involve media insertion if the printer is already activated.

When the controller 214 determines in operation 306 that the selected criteria is satisfied (past expiration date; colorant depleted; maximum output met), then the printer is ready for return and a YES signal 316 is issued to alert the customer of this condition. This YES or “ready for return” indication signal 316 may be accomplished by changing the color of indicator light 216, for instance from a green color for “ready to print” to a red color for “ready to return.” Alternatively, the indicator light 216 may blink in a certain pattern, with the casing 204 displaying a notation correlating the blink pattern with instructions that the unit is ready for return. As another alternative, the printer 110, 200 may simply refuse to be activated or to print when in a “ready for return” state. As a further alternative, the last sheet to be printed may include instructions for how to return the unit.

The “ready for return” indication may be accompanied by instructions telling the customer to perform an optional repacking operation 318, for instance if the unit is to be shipped back to the supplier. In one embodiment, the operator may be requested to return printer 110, 200 in its original shipping container necessitating the repacking operation 318. These instructions may be displayed on the printer casing 204, or casing 204 may display a telephone number followed by the notation “call for return instructions.” If instead, the customer is merely to deliver the unit to a return center, or a drop-off location, for instance a local retail outlet, then repacking may not be required and operation 318 may be omitted. If repacking is not necessary, the customer may proceed directly to a returning operation 320, where the printer 110, 200 may be returned to a recycle drop point, which may be the supplier. The terms “customer,” and “operator” or “user,” are often used interchangeably herein, with the understanding that the customer is typically the one who purchases the printer, whereas anyone may operate or use the printer, including the customer, although the duty typically falls to the original customer or current owner to deal with returning a unit or to delegate that duty to someone else.

Upon receiving the returned printer 110, 200 the supplier or other return agent may conduct an evaluating action 322 to determine whether printer 110, 200 is suitable for refurbishing. For instance, it may be determined that a printer may be refurbished X number of times before components need to be recycled, such as five times (X=5), with the printer being marked internally during each refurbishing cycle. As another example, certain components may be checked for a particular type of wear, and as long as certain limits are not surpassed, the printer may be refurbished. Other criteria may also be used, such as the age of the printer in determining whether it is suitable for refurbishing in operation 322. When the selected refurbishing criteria is exceeded, a NO decision 324 results and printer 110, 200 may then undergo a recycling operation 326.

The supplier or a recycling agent may perform recycling operation 326 on the returned printer 110, 200. In one embodiment, where printer casing 204 is constructed of a cardboard material, the casing 204 may be designed for easy detachment from chassis 202, allowing the detached cardboard to be recycled. Other internal components may be designed for easy detachment from the chassis 202, and these components may then be sorted by material composition for recycling.

For instance, media drive rollers (not shown) are often constructed of an elastomeric material, such as rubber, as are several printhead servicing components, for example caps (not shown) for sealing the printheads during periods of inactivity and wipers (not shown) for cleaning the printheads. The disassembled drive rollers, caps and wipers, may be melted down and used to form new drive rollers, caps and wipers, or other products. A chassis 202 made of aluminum or other metal which may similarly be melted down and used to form new aluminum stock. Plastic components may be similarly melted down and recycled to form new plastic components. Electronics may be recycled or upgraded for use in new printers.

Other components, such as the guide rod 210, may be formed from case hardened steel which shows very little wear over a single printer's lifetime, and may be reinstalled in another printer during operation 326. Designing printer 110, 200 for easy disassembly and recycling yields an environmentally friendly printer that does not clog landfills with additional waste. Many consumers prefer items made from recycled materials, so they are also advertising/sales benefits to providing a recyclable printing mechanism.

Returning to the evaluating operation 322 of FIG. 3, when it is determined that printer 110, 200 it is suitable for refurbishing, a YES decision 328 is made, and the printer undergoes a refreshing operation 330, which may include refilling and/or refurbishing the printer or components thereof. During the refreshing operation 330, various mechanical or moving components of printer 110, 200 may be replaced or upgraded, such as media drive rollers, printhead servicing components, printhead/carriage assemblies, gear assemblies, motors, etc. The refreshing operation 330 also provides excellent opportunity for software upgrades, or upgrades of the controller electronics. During a refilling portion of operation 330, the colorant dispensing cartridges, such as inkjet cartridges 116′, may be refilled or replaced with fresh cartridges.

Following the refreshing operation 330, in a returning operation 332, the refreshed printer may be returned to the original customer for use in the activation operation 304. Alternatively, as indicated by dashed arrows in FIG. 3, the refreshed printer may be shipped to a retailer and undergo a reselling operation 334 for use in the initial purchasing operation 302. It is apparent that in this alternate embodiment, that the original customer or more likely another customer with proceed through operations 302, 304 and 320, and if necessary, the optional repacking operation 318.

FIG. 4 is one embodiment of a disposable inkjet printing system that incorporates an embodiment of the invention that is shown for illustrative purposes only. A digital camera 400 may be coupled to the printer 110 via a communication link 402, such as a docking station, electrical conductor, an optical interface, an infrared port, or a radio wave interface, to name a few.

An operator may print on media 112 a multiple copy of an individual photograph, or may use the system to determine the quality or composition of the photograph, or print one or more copies of the number of photographs selected by the operator to produce output 120.

FIG. 5 is an embodiment of an inkjet printing system that incorporates an embodiment of the invention that is shown for illustrative purposes only. In this embodiment the printer 110 may be a recyclable integrated printer with elements that may be replaced, maintained, refilled or refurbished in refreshing operation 330 (see FIG. 3), or recycled in operation 326 (see FIG. 3) by a supply source 500, which may be an agent or manufacturer. The printer 110 may include a carriage guide or slider rod 510 that slidably supports a carriage 520 for scanning across media 112 when in a printzone, such as printzone 208 (see FIG. 2).

The carriage 520 may transport one or more ink dispensing print cartridges 530 across the printzone for printing a selected image on print media 112. As mentioned above, the print cartridge 530 may be detachably mounted to carriage 520, or the print cartridge 530 may be permanently attached to carriage 520 to form a carriage/cartridge subassembly or subsystem. In one embodiment, the carriage/cartridge subsystem may be an integrated unit including a printhead 532, an ink supply 534, an electrical interconnect 536, a pen driver 538, and carriage 530 a single unit.

In this embodiment, the ink supply 534 and printhead 532 are integral and the operator is not given permission to separate the two. In this embodiment, the printhead 532 is replaced by the refurbisher in the refreshing operation 330 (see FIG. 3). However, if the supplier chooses to conduct the recycling operation 326 (see FIG. 3), then these components are separated for recycling. In the returning operation 320 of FIG. 3, the printer 110 is returned to supply source 500 shown in FIG. 5.

The slider 510 may be a rod upon which the cartridge/carriage subsystem rides while scanning across media 112 in the printzone. A controller 539, which may be an ASIC (application-specific integrated circuit) or other control system, may have a system for collecting data on the use of the printer 110, thereby monitoring the useful life of the printer. This embodiment may also facilitate efficient maintenance, which may extend the life of the printer.

When the printer 110 is nearing the end of its pre-configured life, for instance when the determining operation 306 (see FIG. 3) finds the printer is ready for return, an operator is alerted by YES signal 316 to conduct the returning operation 320, and optionally the repacking operation 318. In this embodiment, the controller 539 is a replaceable controller that allows for easy hardware/software upgrades during the refreshing operation 330 (see FIG. 3). To coordinate firing nozzles of the printhead 532, with motion of carriage 520 along slider 510, and motion of print media 112 through the printzone, the printer 110 may include a data transmission system 540, discussed in further detail below. Print media 112 may be housed in the print media housing 114. As mentioned above with respect to FIG. 2, alternatively media 112 may be manually fed to handling system 206.

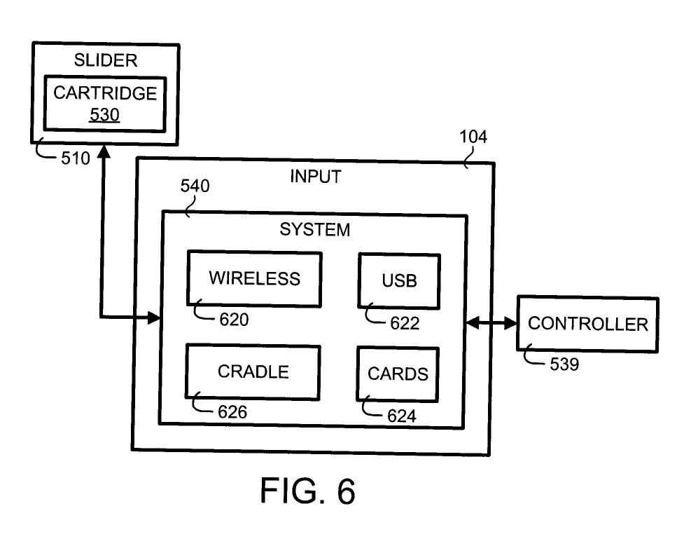

FIG. 6 shows a detailed block diagram of one embodiment of data transmission system 540 of FIG. 5. Referring to both FIGS. 5 and 6, one type of transmission system may include a wireless system 620 which may communicate between the printer controller 539 and the printer cartridge 530. In the illustrated embodiment, transmission system 540 may receive input 104 through a conventional flex cable (not shown).

Alternatively, the transmission system may comprise a wireless data transmission system 620, such as one based on Bluetooth technology, infrared communication technology, optic communication technology, or other suitable wireless data transmission technique. Data communication in one embodiment may be accomplished using USB (universal serial bus) port 622, for instance when coupling printer 110, 200 to other input devices, such as a digital camera or PC (personal computer). Additionally, communication may be made using memory storage devices 624, such as smart cards, camera cards, compact flash, etc.

In another embodiment, data communication may be accomplished through a docking cradle 626, such as a camera cradle integrated into the printer casing 204 as a docking station. In some implementations, the cradle 626 may be configured to interface universally with a variety of different types of cameras. Alternatively, the cradle 626 may be configured for a specific camera 400 which may be bundled with printer 110, 200 for sale at the original point-of-sale. Data may be transmitted through printer controller 539 to cartridge 530. This data may be linked through the slider 520 to carriage 520 then to cartridge 530, eliminating use of the conventional flex cable.

The foregoing has described the principles, embodiments and several illustrative modes of operation of the present invention. However, the invention should not be construed as being limited to the particular embodiments discussed. As an example, the above-described inventions can be used in conjunction with inkjet printers that are not of the disposable, refurbishable, or recyclable type. Thus, the above-described embodiments should be regarded as illustrative rather than restrictive, and it may be appreciated that variations may be made in those embodiments by workers skilled in the art without departing from the scope of the present invention as defined by the following claims.

1. A printing apparatus, comprising:
a chassis;
a print engine supported by the chassis; and
a casing of a cardboard material comprising cellulose fiber attached to the chassis and surrounding the print engine when attached to the chassis.

2. The printing apparatus of claim 1, further comprising a waterproof coating applied to an exterior surface of the casing.

3. The printing apparatus of claim 1, further comprising a metallic paint coating applied to an exterior surface of the casing.

4. The printing apparatus of claim 1, further comprising a print engine support structure supported by the chassis to support the print engine over a printzone, wherein the print engine support structure comprises a reciprocating carriage that transports the print engine across the printzone during printing.

5. The printing apparatus of claim 1, further comprising a battery disposed inside the casing when attached to the chassis.

6. The printing apparatus of claim 1, further comprising:
a media handling system which places media in a printzone for receiving colorant dispensed from the print engine;
a controller in communication with the print engine and the media handling system; and
a data transmission system that receives input information from an external source and communicates the input information to the controller.

7. The printing apparatus of claim 6, wherein the data transmission system receives the input information via wireless communication technology, memory storage device technology, docking station technology, or universal serial bus technology.

8. A printing apparatus, comprising:
a chassis;
a print engine supported by the chassis; and
a casing attached to the chassis and surrounding the print engine when attached to the chassis, with the casing being devoid of user input controls.

9. The printing apparatus of claim 8, further comprising a media handling system which places media in a printzone for receiving colorant dispensed from the print engine, wherein the media handling system includes a media input which upon receiving media activates the printing apparatus.

10. The printing apparatus of claim 8 wherein the casing prohibits user access to replenish colorant dispensed by the print engine.

11. The printing apparatus of claim 10, further comprising:
a controller which generates a print signal;
wherein the print engine dispenses colorant in response to the print signal; and
wherein the controller monitors the amount of colorant available to the print engine, and instructs the print engine to generate a return instructions message when the colorant reaches a selected level.

12. The printing apparatus of claim 8, wherein the casing is of a cardboard material comprising a cellulose fiber.

13. A printing apparatus, comprising:
a chassis;
a print engine supported by the chassis; and
a casing attached to the chassis to surround the print engine, wherein the casing is devoid of an access mechanism to prohibit user access to the print engine when attached to the chassis.

14. The printing apparatus of claim 13, wherein the casing is of a cardboard material comprising a cellulose fiber.

15. The printing apparatus of claim 13, wherein the casing is devoid of user input controls.

16. The printing apparatus of claim 13, further comprising a battery disposed inside the casing when attached to the chassis.

17. The printing apparatus of claim 13, further comprising:
a media handling system a media handling system which places media in a printzone for receiving colorant dispensed from the print engine;
a controller in communication with the print engine and the media handling system; and
a data transmission system that receives input information from an external source and communicates the input information to the controller, wherein the data transmission system receives the input information via wireless communication technology, memory storage device technology, docking station technology, or universal serial bus technology.

18. A printing apparatus, comprising:
a chassis;
a print engine supported by the chassis;
a casing attached to the chassis to surround the print engine; and
a battery disposed inside the casing and chassis.

19. The printing apparatus of claim 18, wherein the casing is of a cardboard material comprising a cellulose fiber.

20. The printing apparatus of claim 18, wherein the casing prohibits user access to replenish colorant dispensed by the print engine when attached to the chassis, and the casing is devoid of user input controls.

21. The printing apparatus of claim 18, further comprising:
a media handling system a media handling system which places media in a printzone for receiving colorant dispensed from the print engine;
a controller in communication with the print engine and the media handling system; and
a data transmission system that receives input information from an external source and communicates the input information to the controller, wherein the data transmission system receives the input information via wireless communication technology, memory storage device technology, docking station technology, or universal serial bus technology.

22. A printing apparatus, comprising:
a chassis;
a print engine supported by the chassis;
a casing of a cardboard material comprising cellulose fiber detachably attached to the chassis and surrounding the print engine when attached to the chassis, wherein the casing is devoid of user input controls, and wherein the casing prohibits user access to replenish colorant dispensed by the print engine when attached to the chassis;
a battery disposed inside the casing when attached to the chassis;
a media handling system a media handling system which places media in a printzone for receiving colorant dispensed from the print engine;
a controller in communication with the print engine and the media handling system; and
a data transmission system that receives input information from an external source and communicates the input information to the controller, wherein the data transmission system receives the input information via wireless communication technology, memory storage device technology, docking station technology, or universal serial bus technology.

23. A business method, comprising:
selling a printer having a controller configured with return criteria; and
instructing the customer to return the printer when said return criteria is met.

24. the business method of claim 23, further comprising refreshing the returned printer.

25. The method of claim 24, wherein said refreshing comprises refurbishing components of the returned printer.

26. The method of claim 23, wherein said refreshing comprises refilling colorant dispensed by the printer with fresh colorant.

27. The method of claim 23, wherein said refreshing comprises replacing a depleted colorant dispensing print engine with a fresh colorant dispensing print engine having a supply of colorant.

28. The method of claim 23, further comprising repacking said printer for return to a destination following said instructing.

29. The method of claim 23, wherein said return criteria comprises an expiration date.

30. The method of claim 23, wherein said return criteria comprises depletion of colorant dispensed by a print engine of the printer.

31. The method of claim 23, wherein said return criteria comprises a selected maximum output.

32. The method of claim 23, further comprising returning the refreshed printer to said customer.

33. The method of claim 23, further comprising reselling the refreshed printer to another customer.

34. The method of claim 23, further comprising prohibiting further printing when said return criteria is met.

35. The method of claim 23, further comprising:
evaluating the returned printer to determine whether refreshing as possible; and
when refreshing is not possible, recycling components of said printer.

36. The method of claim 23, further comprising:
repacking said printer for return to a destination following said instructing;
prohibiting further printing when said return criteria is met;
wherein said refreshing comprises refurbishing components of the returned printer, and supplying fresh colorant for dispensing;
wherein said return criteria comprises an expiration date, depletion of colorant, or a selected maximum output; and
returning the refreshed printer to said customer, or reselling the refreshed printer to another customer.

37. A business method, comprising:
purchasing a printer;
inserting media into the printer;
requesting the printer to print;
waiting while the printer determines whether the printer is ready for return;
when the printer is ready for return, returning the printer for refreshing; and
following refreshing, receiving the refreshed printer for subsequent printing.

38. The business method of claim 37, further comprising repacking said printer prior to said returning.

39. A business method, comprising:
receiving a printer having a depleted colorant from a customer; and
replenishing said depleted colorant.

40. The business method of claim 39, further comprising returning said printer with replenished colorant to the customer or a reseller.

41. The business method of claim 39, further comprising replacing worn components of said printer prior to said returning.

42. The business method of claim 39, further comprising upgrading software of said printer prior to said returning.

43. The business method of claim 39, further comprising:
evaluating said returned printer according to a refurbish criteria prior to said replenishing;
when the refurbish criteria is met, continuing with said replenishing and said returning; and
when the refurbish criteria is not met, omitting said replenishing and said returning, and recycling components of said printer.

44. A printing apparatus, comprising:
means for supporting a print engine in a printzone;
means for supplying media to the printzone to receive colorant dispensed from said print engine;
means for surrounding said print engine with a cardboard material comprising a cellulose fiber to prohibit user access to said printhead; and
means for storing an expiration use date, or a maximum number of printed upon media sheets, beyond which colorant is no longer dispensed.

45. The printing apparatus of claim 44, further comprising means for powering the printer housed internal to said means for surrounding said printhead.

46. The printing apparatus of claim 44, further comprising means for receiving input information from an external source comprising wireless communication technology, memory storage device technology, docking station technology, or universal serial bus technology.
